(19) United States
(12) Patent Application Publication
(10) Pub. No.: US 2026/0200078 A1
(43) Pub. Date: Jul. 16, 2026

(54) ROBOT SYSTEM AND CONTROL METHOD

(71) Applicant: KABUSHIKI KAISHA YASKAWA DENKI, Kitakyushu-shi (JP)

(72) Inventors: Keita MORISAKI, Fukuoka (JP); Yuta ARITA, Fukuoka (JP); Takahiro MAEDA, Fukuoka (JP)

(21) Appl. No.: 19/558,489

(22) Filed: Mar. 6, 2026

Related U.S. Application Data
(63) Continuation of application No. PCT/JP2024/032708, filed on Sep. 12, 2024.
(60) Provisional application No. 63/582,233, filed on Sep. 12, 2023.

(51) Int. Cl. B25J 9/16

(52) U.S. Cl. CPC B25J 9/161; B25J 9/1656; B25J 9/1697; G05B 2219/39001

(57) ABSTRACT

A robot system may includes: a robot drive device configured to drive a robot; and a computing device configured to perform network communication with the robot drive device and to execute an application for control of the robot by the robot drive device, wherein, while the robot drive device is driving the robot, a cyclic communication for cyclically communicating data and an acyclic communication for non-cyclically communicating data are performed between the robot drive device and the computing device by the network communication.

### CROSS-REFERENCE TO RELATED APPLICATIONS

This application is a continuation application of PCT Application No. PCT/JP2024/032708, filed on September 12, 2024, which claims the benefit of priority from U.S. Provisional Patent Application No. 63/582233, filed on September 12, 2023. The entire contents of the above listed PCT and priority applications are incorporated herein by reference.

### BACKGROUND

### Field

The present disclosure relates to a robot system and a control method.

### Description of the Related Art

Japanese Unexamined Patent Publication No. 2019-220135 A discloses a motion control device for motion control of a device to be controlled, in which both a non-real-time OS and a real-time OS are installed. The motion control device includes a shared memory that can be commonly referenced and written by each functional unit in the non-real-time OS and each functional unit in the real-time OS.

### SUMMARY

Disclosed herein is a robot system. The robot system may include: a robot drive device configured to drive a robot; and a computing device configured to perform network communication with the robot drive device and to execute an application for control of the robot by the robot drive device, wherein, while the robot drive device is driving the robot, a cyclic communication for cyclically communicating data and an acyclic communication for non-cyclically communicating data are performed between the robot drive device and the computing device by the network communication.

Additionally, a robot system is disclosed herein. The robot system may include: a first CPU configured to control a robot by executing a real-time operating system; a second CPU communicable with the first CPU and configured to execute a non-real-time operating system; and a GPU controlled by the second CPU, wherein the second CPU is configured to cause the GPU to perform a matrix operation related to generating a path for the robot while the first CPU is controlling the robot, and wherein the first CPU is configured to, based on computation results by the second CPU and the GPU, cause the robot to move along the path.

Additionally, a control method is disclosed herein. The control method may include: driving a robot by a robot drive device; executing, by a computing device configured to perform network communication with the robot drive device, an application for control of the robot by the robot drive device; and performing, while the robot drive device driving the robot, a cyclic communication for cyclically communicating data and an acyclic communication for non-cyclically communicating data between the robot drive device and the computing device by the network communication.

### BRIEF DESCRIPTION OF THE DRAWINGS

FIG. 1 is a diagram schematically illustrating a configuration of a robot system.

FIG. 2 is a block diagram illustrating an example functional configuration of a computing device and a robot drive device.

FIG. 3 is a block diagram illustrating a modified example of the computing device and the robot drive device.

FIG. 4 is a block diagram illustrating another modified example of the computing device and the robot drive device.

FIG. 5 is a block diagram illustrating an example hardware configuration of the computing device and the robot drive device.

FIG. 6 is a flowchart illustrating an example communication start procedure.

FIG. 7 is a flowchart illustrating an example request handling procedure in the computing device.

FIG. 8 is a flowchart illustrating an example acyclic communication procedure.

FIG. 9 is a flowchart illustrating an example request handling procedure in the robot drive device.

FIG. 10 is a flowchart illustrating an example cyclic communication procedure in the robot drive device.

FIG. 11 is a flowchart illustrating an example cyclic communication procedure in the computing device.

### DETAILED DESCRIPTION

In the following description, with reference to the drawings, the same reference numbers are assigned to the same components or to similar components having the same function, and overlapping description is omitted.

### Robot System

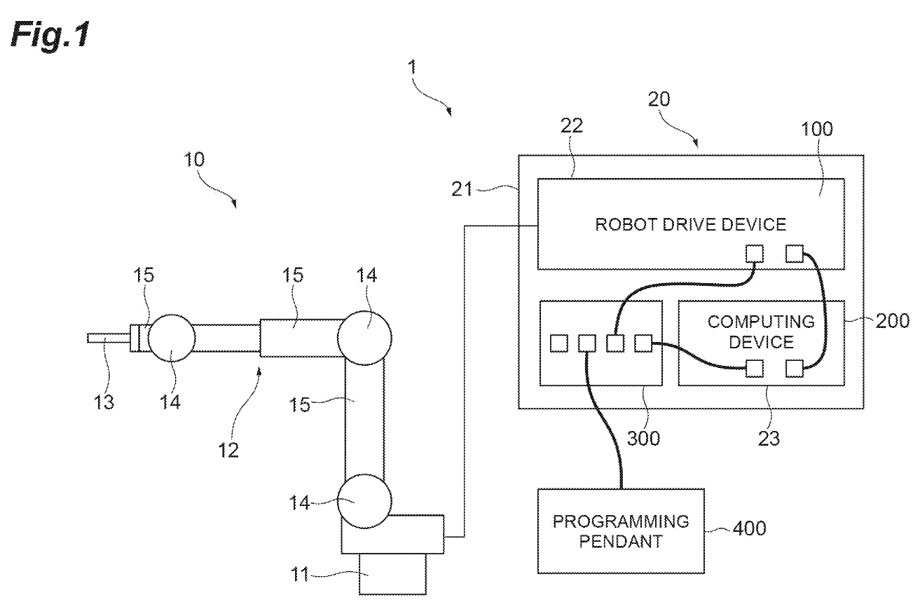

A robot system 1 illustrated in FIG. 1 is a system for causing a robot 10 to perform various tasks. Examples of tasks performed by the robot 10 include transfer of workpieces, processing of workpiece, and assembly of workpieces in an industrial production line. For example, the robot system 1 includes the robot 10 and a control system 20. The robot 10 is, for example, a vertical articulated robot and includes a base 11, an articulated arm 12, and an end effector 13. The base 11 is installed on a floor surface, wall surface, or ceiling surface of the work area of the robot 10. The base 11 may be installed on a mobile body such as an automated guided vehicle. The articulated arm 12 is connected to the base 11. The articulated arm 12 includes a plurality of links 15 connected in series from the base 11 at a plurality of joints 14. The end effector 13 is connected to the tip of the articulated arm 12 and acts on a workpiece for the above-described tasks. Examples of the end effector 13 include a hand for gripping a workpiece, a suction unit for adsorbing a workpiece, a tool for processing a workpiece, and a tool for assembling a workpiece (for example, a fastening tool, a welding tool, etc.). The articulated arm 12 changes the position and orientation of the end effector 13 by changing the angle of each of the plurality of joints 14 using actuators such as electric actuators. The configuration of the robot 10 is merely an example and may be modified. For example, the robot 10 may be a SCARA-type robot.

The control system 20 is a system for controlling the robot 10. For example, the control system 20 includes a robot drive device 100 and a computing device 200. The robot drive device 100 drives the robot 10. For example, the robot drive device 100 drives the plurality of joints 14 of the articulated arm 12 and the end effector 13. For example, the robot drive device 100 repeatedly executes a control cycle at a constant driving period (a fixed cycle length), the control cycle including acquiring feedback information indicating the state of the robot 10 (for example, the angle of each of the plurality of joints 14) and driving the robot 10 so as to reduce the difference between the target state of the robot 10 and the state of the robot 10 based on the feedback information. Driving the robot 10 includes, for example, supplying drive power to a plurality of actuators that respectively drive the plurality of joints 14. Driving the robot 10 also includes maintaining a certain posture of the robot 10 by supplying drive power to the plurality of actuators.

The computing device 200 is configured to perform network communication with the robot drive device 100. The computing device 200 is capable of executing an application for control of the robot 10 by the robot drive device 100. The network communication is digital communication performed by identifying a destination using addressing such as an IP address or MAC address. The network communication is performed by layered protocols such as the TCP/IP model or the OSI model. For example, the TCP/IP model includes a network interface layer, an internet layer, a transport layer, and an application layer.

The application for control of the robot 10 is an application that generates information for executing the intended control. The application is executed, for example, while the robot drive device 100 is driving the robot 10. The period during which the robot drive device 100 is driving the robot 10 means, for example, the so-called servo-on period, and includes the period during which the robot 10 is maintained in a certain posture by supplying drive power to the plurality of actuators.

For example, the application is a program that executes processing not included in a program executed by the robot drive device 100 (hereinafter referred to as a “robot program”). Examples of the application include a vision application, a force sense application, and a path generation application as described below. The vision application is an application that performs image processing on images captured by a camera provided on the robot 10 or a camera installed around the robot 10, and extracts information for control of the robot. Examples of information for control of the robot include the position of a workpiece and the position of a peripheral device of the robot 10. The information extracted by image processing is used for generating a motion path of the robot 10, for example. The motion path is information that defines the transition of the position and orientation of the end effector 13. The image processing may include a matrix operation suitable for execution by a graphics processing unit (GPU). The force sense application is an application that generates an operation to be executed by the robot 10 according to a force detected by a force sensor. The path generation application is an application that generates a motion path of the robot 10 for executing a task, by simulation (for example, interference check) based on the task to be executed by the robot 10 and three-dimensional models of the robot 10 and surrounding objects. The simulation such as interference check may include a matrix operation suitable for execution by a graphics processing unit (GPU).

In the illustrated example, the control system 20 includes the robot drive device 100, the computing device 200, and a network switch 300, all housed in a housing 21 of the robot system 1, and a programming pendant 400 usable at a position remote from the housing 21. The robot drive device 100 may be unitized by a sub-housing 22 or the like so as to be collectively inserted into and removed from the housing 21. Similarly, the computing device 200 may be unitized by a sub-housing 23 or the like so as to be collectively inserted into and removed from the housing 21. The programming pendant 400 is a device operated by an operator to teach the robot drive device 100 the operation to be executed by the robot 10. The programming pendant 400 may be configured using hardware specialized for operation teaching, or may be configured using a general-purpose computer such as a tablet computer and a teaching application. The network switch 300 is connected to each of the robot drive device 100, the computing device 200, and the programming pendant 400 via a LAN cable or the like, and transfers network communication data among the robot drive device 100, the computing device 200, and the programming pendant 400. For example, the network switch 300 transfers data based on a MAC address at the network interface layer of the TCP/IP model. The robot drive device 100 and the computing device 200 may be directly connected to each other in addition to being connected via the network switch 300. For example, the robot drive device 100 and the computing device 200 may be directly connected to each other by a LAN cable different from the LAN cable connecting the robot drive device 100 and the network switch 300 and the LAN cable connecting the computing device 200 and the network switch 300.

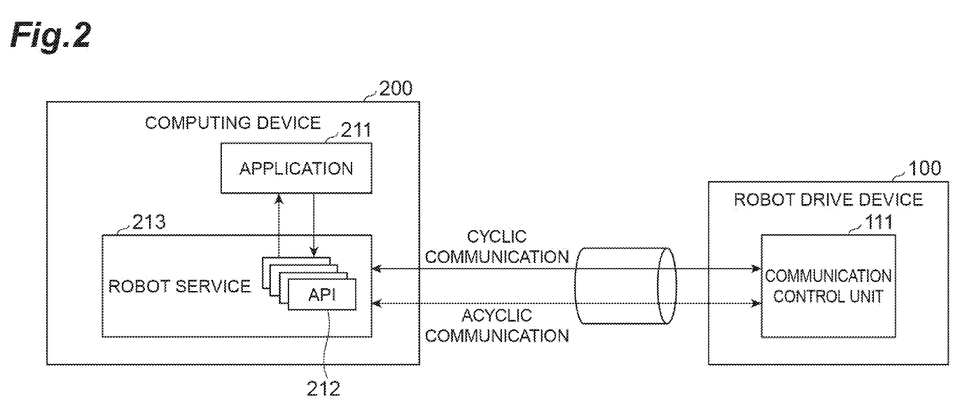

In order to reflect the execution result of the application by the computing device 200 in the control of the robot 10 while the robot drive device 100 is driving the robot 10, it is advantageous to perform timely communication between the robot drive device 100 and the computing device 200 with limited communication resources. Accordingly, as illustrated in FIG. 2, the control system 20 is configured to perform, at least while the robot drive device 100 is driving the robot 10, a cyclic communication for cyclically communicating data and an acyclic communication for non-cyclically communicating data between the robot drive device 100 and the computing device 200.

With the control system 20, resources for robot control can be extended from the robot drive device 100 to the computing device 200, so that various applications for robot control can be readily constructed beyond the resource constraints of the robot drive device 100. In addition, in the exchange of data and processing results for executing the application, communication suitable for the nature of the processing or application can be selected from cyclic communication and acyclic communication. For example, by cyclic communication, data (for example, position data) corresponding to the driving period of the robot drive device 100 can be reliably exchanged. By acyclic communication, temporary information can be timely (for example, immediately) without generating a cyclic communication load. By combining these communications, timely communication can be performed while suppressing communication load while the robot drive device 100 is driving the control system 20. For example, a plurality of data sets for which periodicity is prioritized rather than immediacy can be multiplexed onto cyclic data sent by cyclic communication, and data sets for which immediacy is prioritized rather than periodicity can be individually sent by acyclic communication, thereby enabling timely communication while suppressing communication load. Since the communication load is suppressed, a burden for the application developer to be aware of communication constraints at the time of application construction may be reduced, and a more straightforward development environment may be provided.

As described above, the period during which the robot drive device 100 is driving the robot 10 means, for example, the so-called servo-on period, and includes the period during which the robot 10 is maintained in a certain posture by supplying drive power to the plurality of actuators. The period during which the robot drive device 100 is driving the robot 10 may also include the period during which the robot 10 is moving.

The cyclic communication may be strictly periodic communication conforming to a periodic communication standard (for example, EtherCAT (registered trademark)), but may not be limited to strictly periodic communication conforming to a periodic communication standard. For example, the cyclic communication may be communication performed at approximately a fixed period length of period based on a system timer of at least one of the robot drive device 100 and the computing device 200. Also, the cyclic communication may be omitted in a cycle in which there is no data to be transmitted.

Examples of data sets included in cyclic data (hereinafter referred to as “first cyclic data”) from the robot drive device 100 to the computing device 200 include data sets indicating the current state of the robot 10 such as the current position of the robot 10 (for example, the current angle of each of the plurality of joints 14), data sets indicating the status of processing being executed by the robot drive device 100 in response to a request from the computing device 200, and the like. Examples of data sets included in cyclic data (hereinafter referred to as “second cyclic data”) from the computing device 200 to the robot drive device 100 include the target posture and the like of the robot 10 for each control cycle based on a motion path calculated by the computing device 200. The target posture of the robot 10 may be the target angle of each of the plurality of joints 14, or the target position and target orientation of the end effector 13. Examples of data sets transmitted from the computing device 200 to the robot drive device 100 by acyclic communication include data sets requesting transmission of configuration information of the robot 10, data sets requesting writing of settings to the robot drive device 100 from the computing device 200, data sets requesting servo-on to the robot drive device 100 from the computing device 200, and data sets requesting one-shot operation to the robot drive device 100 from the computing device 200. The data set requesting one-shot operation is, for example, an operation command requesting the robot 10 to move to a target posture.

The robot drive device 100 may include, as a functional block, a communication control unit 111. The communication control unit 111 is configured to control the cyclic communication and the acyclic communication in response to a request from the computing device 200. For example, when the request from the computing device 200 is a one-time request, the communication control unit 111 transmits a response to the request by acyclic communication. When the request from the computing device 200 is a cyclic request, the communication control unit 111 transmits a response to the request by cyclic communication. The communication control unit 111 automatically assigns suitable communication in accordance with the nature of the request. Therefore, at least communication from the robot drive device 100 to the computing device 200 can be encapsulated, and the application developer can benefit from a functional robot development environment without being aware of communication.

A one-time request (a request for one-time response) is a request that is completed by responding once to the request. A cyclic request (a request for cyclic response) is a request that requires repeated cyclic responses to the request. For example, when the communication control unit 111 receives a one-time request, it prepares a response to the received request and immediately transmits the prepared response to the computing device 200. When receiving a cyclic request, the communication control unit 111 includes the response to the request in the first cyclic data and transmits the first cyclic data to the computing device 200.

The computing device 200 includes the above-described application 211 and a plurality of APIs 212. The computing device 200 may include a plurality of applications 211. Further, the computing device 200 includes, as a functional block, a robot service 213. Each of the plurality of APIs 212 is an Application Programming Interface callable from the application 211.

The robot service 213 is configured to select one or both of a one-time request and a cyclic request according to the API 212 called from the application 211, and to transmit the selected request to the communication control unit 111. Communication from the computing device 200 to the robot drive device 100 can also be encapsulated. Since either a one-time request or a cyclic request is selected in accordance with the API, an application can be readily constructed using the API without being aware of the type of communication.

For example, the processing to be executed by the robot service 213 is predetermined for each of the plurality of APIs 212. Hereinafter, the processing to be executed by the robot service 213 is referred to as “service processing”. When any of the plurality of APIs 212 is called, the robot service 213 selects and executes the service processing corresponding to the called API 212. If the selected service processing includes a one-time request to the communication control unit 111, the one-time request is selected by selecting the service processing. If the selected service processing includes a cyclic request to the communication control unit 111, the cyclic request is selected by selecting the service processing. When the robot service 213 selects service processing including a one-time request, the robot service 213 transmits the one-time request to the communication control unit 111 as part of the service processing. When the robot service 213 selects service processing including a cyclic request, it transmits the cyclic request to the communication control unit 111 as part of the service processing.

The robot service 213 may perform network communication with the application 211 in addition to network communication with the communication control unit 111. For example, the computing device 200 may include one or more virtualized containers. A container is a virtual execution environment that packages libraries, configuration files, etc. for the operation of an application as a single package, and allows the application to be executed independently of other containers or the host system (for example, operating system).

The one or more containers may include an application container capable of network communication with the robot service 213, and the application 211 may be stored in the application container. The computing device 200 may include, as one or more containers, an application container and a service container capable of network communication with each other, and the application 211 may be stored in the application container and the robot service 213 may be stored in the service container.

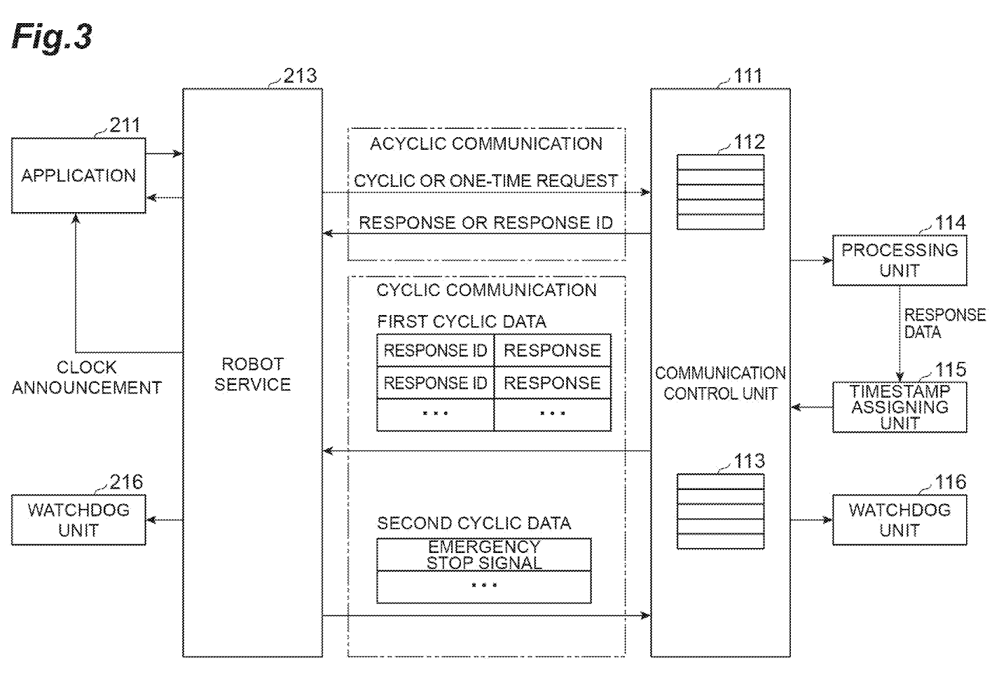

As illustrated in FIG. 3, the computing device 200 (robot service 213) may transmit a one-time request to the communication control unit 111 by acyclic communication. In the acyclic communication for transmitting a one-time request, the communication control unit 111 transmits a response to the request to the robot service 213.

The computing device 200 (robot service 213) may be configured to transmit a cyclic request to the communication control unit 111 by acyclic communication. When receiving a cyclic request by acyclic communication, the communication control unit 111 is configured to, in case of receiving the cyclic request by the acyclic communication, transmit a response to the request to the computing device 200 by cyclic communication. Since the request from the robot service 213 is sent by acyclic communication, the request can be transmitted to the robot drive device 100 without waiting for the cycle of cyclic communication. In addition, if the request is a cyclic request, the requested data can be included in the first cyclic data repeatedly transmitted by cyclic communication. Accordingly, calculation cost and communication cost can be reduced.

For example, when receiving a cyclic request by acyclic communication, the communication control unit 111 issues a response ID for the request and transmits the issued response ID to the robot service 213 by acyclic communication. The robot service 213 stores the received response ID in association with the application 211 (the application 211 that caused the robot service 213 to transmit the cyclic request). Thereafter, the communication control unit 111 attaches the issued response ID to the response to the request and includes the response with the response ID in the first cyclic data, which is repeatedly transmitted to the robot service 213. Each time the robot service 213 receives the first cyclic data from the communication control unit 111, the robot service 213 returns the response to the application 211 associated with the response ID based on the response ID attached to the response. In addition to the response ID, the communication control unit 111 may further attach the data size of the response to the response to the request and transmit the response to the robot service 213. The robot service 213 may extract the response corresponding to the request from the first cyclic data based on the response ID and the data size, and return the extracted response to the application 211 associated with the response ID.

The communication control unit 111 may be configured to perform the cyclic communication and the acyclic communication with the computing device 200 using an identical communication resource, and may prioritize the cyclic communication over the acyclic communication. The reliability of the cyclic communication can be maintained, and the robot system 1 capable of stable operation can be constructed.

Examples of the identical communication resource include a physically identical communication path (for example, communication line). The identical communication resource may not be limited to be wired and may be an identical communication band in wireless communication.

For example, the communication control unit 111 prioritizes the cyclic communication over the acyclic communication so that the cyclic communication is maintained. For example, at the timing of transmitting the first cyclic data, the communication control unit 111 allocates the communication resource to the cyclic data first and allocates the surplus of the communication resource to the data of the acyclic communication.

The communication control unit 111 may include: one or more queues 112 for cyclic communication as queues configured to hold data sequentially sent to the computing device 200; and one or more queues 113 for acyclic communication as queues configured to hold data sequentially sent to the computing device 200. At a communication timing of the cyclic communication, the communication control unit 111 may prioritize data held in the one or more queues 112 for cyclic communication over data held in the one or more queues 113 for acyclic communication and transmit the prioritized data to the computing device 200. Since the queue 112 for cyclic communication is prioritized over the queue 113 for acyclic communication, the communication resource for cyclic communication can be prevented from being squeezed.

For example, the communication control unit 111 may include the queues 112 and 113 in the above-described transport layer, store responses to cyclic requests in the queue 112, and store responses to one-time requests in the queue 113. At a communication timing of the cyclic communication, the communication control unit 111 includes data held in the one or more queues 112 in a transmission packet to the robot service 213, and includes at least a part of the data held in the one or more queues 113 in a surplus transmission packet.

The communication control unit 111 may further include, in addition to one or more queues 113 with lower priority than the one or more queues 112, one or more queues 113 with higher priority than the one or more queues 112. Hereinafter, the one or more queues 113 with lower priority than the one or more queues 112 are referred to as “normal queues 113”, and the one or more queues 113 with higher priority than the one or more queues 112 are referred to as “high-priority queues 113”. When the communication control unit 111 includes both normal queues 113 and high-priority queues 113, the communication control unit 111 may store responses to one-time requests the priority of which may be lowered in the normal queues 113, and store responses to high-priority one-time requests in the high-priority queues 113. At a communication timing of the cyclic communication, the communication control unit 111 may prioritize data held in the high-priority queues 113 over data held in the queues 112 and transmit the prioritized data to the computing device 200. The delay of responses to high-priority one-time requests can be prevented. Each of the queues 112 and 113 is configured, for example, by a First In First Out (FIFO) memory or the like capable of setting priority.

The robot drive device 100 may further include, as functional blocks, a processing unit 114 and a timestamp assigning unit 115. The processing unit 114 is configured to repeat processing (for example, the above-described control cycle) for driving the robot 10 at a fixed period length (for example, the above-described control cycle). The timestamp assigning unit 115 is configured to assign a timestamp to a processing result by the processing unit 114. Examples of the processing result include feedback information acquired in the above-described control cycle and information on drive power output in the above-described control cycle. When a non-cyclic request received by the communication control unit 111 requires processing by the processing unit 114, the processing unit 114 may perform one-time processing corresponding to the non-cyclic request and return the processing result to the communication control unit 111. Examples of non-cyclic requests include a request for reading setting information in the robot drive device 100 and a one-time confirmation request for feedback information.

The communication control unit 111 may be configured to transmit, by cyclic communication, the processing result assigned with a timestamp by the timestamp assigning unit 115 to the computing device 200. For example, the communication control unit 111 may include the processing result assigned with a timestamp by the timestamp assigning unit 115 in the above-described first cyclic data and transmit the first cyclic data to the computing device 200.

Based on a timestamp, the computing device 200 can execute processing while reducing the influence of jitter in the cyclic communication. For example, even if the timing of receiving the processing result by the computing device 200 varies due to cyclic communication, the processing result can be used in calculation in the application 211 as being at the timing indicated by the timestamp, thereby eliminating the influence of the variation. The timing at which the timestamp assigning unit 115 assigns a timestamp may be the timing at which the processing result is acquired by the processing unit 114, or the timing at which the communication control unit 111 includes the processing result in the first cyclic data.

The communication control unit 111 may be configured to repeatedly transmit the first cyclic data to the computing device 200 by cyclic communication regardless of whether there is information to be transmitted by the cyclic communication. Since the first cyclic data is periodically sent by cyclic communication, various processing can be constructed on the assumption that the first cyclic data is periodically received in the computing device 200. For example, the computing device 200 can determine that communication with the robot drive device 100 is maintained by the periodic arrival of the first cyclic data. Also, processing synchronized with the processing in the robot drive device 100 can be executed based on the timing of receiving the first cyclic data.

The communication control unit 111 may be configured to transmit the first cyclic data to the computing device 200 by performing the cyclic communication at a cycle synchronized with the driving period of the robot 10 in the robot drive device 100. Since the first cyclic data is sent at a period synchronized with the driving period of the robot 10, the computing device 200 can perform calculation synchronized with the driving period of the robot 10. In the robot drive device 100, a plurality of processes may be repeated at mutually different periods. For example, in addition to the drive processing of the robot 10 repeated at the driving period, I/O processing for checking input/output from outside to the robot drive device 100 may be repeated at an I/O period different from the driving period. The communication control unit 111 may transmit the first cyclic data to the computing device 200 by performing the cyclic communication at a period synchronized with the I/O period. When the I/O period is synchronized with the driving period, performing the cyclic communication at a period synchronized with the I/O period is included in performing the cyclic communication at a cycle synchronized with the driving period.

The computing device 200 may be configured to perform, in response to receiving data from the robot drive device 100, a clock announcement to the application executed on the computing device 200. For example, each time the computing device 200 receives the first cyclic data from the robot drive device 100, the computing device 200 may perform a clock announcement to the application executed on the computing device 200. The application executed in the computing device 200 can acquire the timing synchronized with the driving period of the robot by the clock announcement and can execute processing in accordance with the timing. Therefore, the burden on a system integrator or service vendor in constructing the application executed in the computing device 200 can be greatly reduced. When the driving period and the I/O period described above are synchronized with each other and the driving period is an integer multiple of the I/O period, the communication control unit may include cycle identification information for identifying whether the data transmission is at the driving period or at the I/O period in the first cyclic data and transmit it to the computing device 200. The computing device 200 may perform a clock announcement including notification of the cycle identification information. Based on the notification of the cycle identification information, an application more suitable for the operation of the robot drive device 100 can be readily constructed.

The computing device 200 may be configured to transmit the second cyclic data to the robot drive device 100 by cyclic communication regardless of whether there is information to be transmitted by the cyclic communication. The robot drive device 100 may further include, as a functional block, a watchdog unit 116. The watchdog unit 116 is configured to confirm the integrity of the communication with the computing device 200 based on the second cyclic data. the robot drive device 100 can confirm that the computing device 200 is operating and capable of communication. This confirmation result can also be used as a control condition for error, alarm, emergency stop, or branching of processing in the robot drive device 100.

For example, when the communication control unit 111 cannot receive the second cyclic data at the timing when the second cyclic data is supposed to be received, the watchdog unit 116 determines that the communication with the computing device 200 is not reliable. The robot drive device 100 may stop control of the robot 10 based on the second cyclic data. The robot drive device 100 may perform an emergency stop of the robot 10 or output an alarm to the operator. The robot drive device 100 may temporarily stop the robot 10 and resume the operation of the robot 10 in response to the communication with the computing device 200 returning to a reliable state.

The watchdog unit 116 may be configured to refrain from confirming the integrity based on the second cyclic data until the communication control unit 111 establishes the cyclic communication, and may be configured to start confirming the integrity based on the second cyclic data after the communication control unit 111 establishes the cyclic communication. Erroneous detection of loss of integrity in a situation where merely waiting for the establishment of cyclic communication can be prevented.

Instead of the watchdog unit 116 in the robot drive device 100 or in addition to the watchdog unit 116 in the robot drive device 100, the computing device 200 may further include a watchdog unit 216. When the robot service 213 cannot receive the first cyclic data at the timing when the first cyclic data is supposed to be received, the watchdog unit 216 determines that the communication with the robot drive device 100 is not reliable. The robot service 213 may transmit a command to the communication control unit 111 to perform an emergency stop of the robot 10 or output an alarm to the operator. The robot service 213 may temporarily stop transmission of the second cyclic data to the robot drive device 100 and resume transmission of the second cyclic data to the robot drive device 100 in response to the communication with the robot drive device 100 returning to a reliable state.

The watchdog unit 216 may be configured to refrain from confirming the integrity based on the first cyclic data until the robot service 213 establishes the cyclic communication, and may be configured to start confirming the integrity based on the second cyclic data after the robot service 213 establishes the cyclic communication. Erroneous detection of loss of integrity in a situation where merely waiting for the establishment of cyclic communication can be prevented.

The computing device 200 may be configured to include an emergency stop signal in the second cyclic data and transmit the second cyclic data to the robot drive device 100 so as to cause the robot drive device 100 to perform an emergency stop. When the second cyclic data includes the emergency stop signal, the robot drive device 100 may be configured to perform an emergency stop of the robot 10.

By utilizing the second cyclic data periodically transmitted to the robot drive device 100, the computing device 200 can cause the robot drive device 100 to perform an emergency stop. Even if the second cyclic data including the emergency stop signal is not transmitted due to a communication failure, the robot drive device 100 can be caused to perform an emergency stop based on the monitoring result by the watchdog unit 116. In addition, when the cyclic communication is performed at a period less than or equal to the driving period of the robot drive device 100, the second cyclic data is also transmitted at a period less than or equal to the driving period of the robot drive device 100, so the number of driving periods executed until the emergency stop signal is transmitted can be suppressed, and the robot drive device 100 can be quickly stopped in an emergency. Even when there are no spare resources in the resource for acyclic communication due to a request such as file acquisition, the delay in stopping the robot drive device 100 can be prevented.

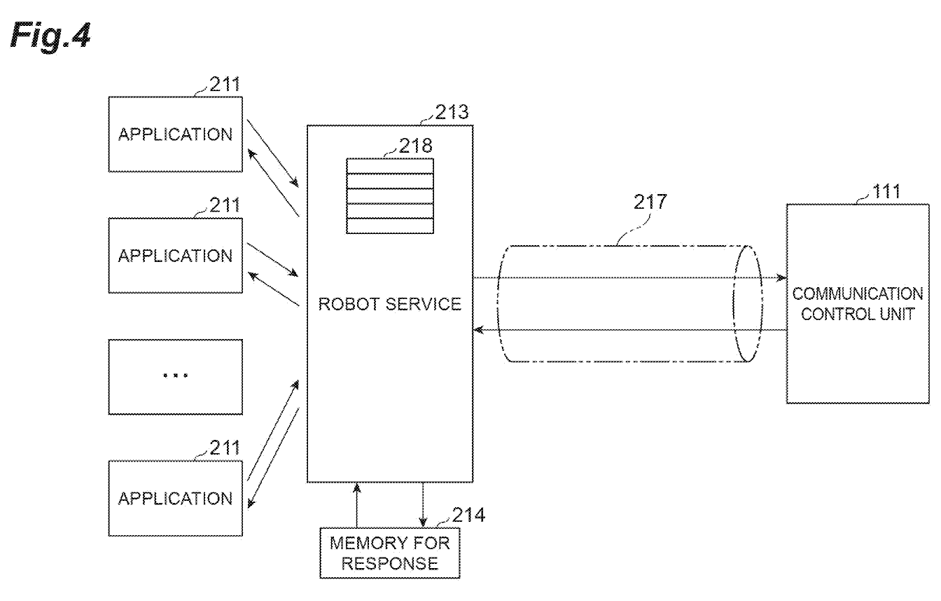

As illustrated in FIG. 4, the robot service 213 may be configured to: sequentially transmit n requests from one or more applications 211 to the robot drive device using m sockets 217, where m is fewer than n; and receive a response to each of the n requests via the m sockets 217 (one socket in the figure), and return each received response to a corresponding request. By sharing at least one of the m sockets 217 among two or more requests, communication resources can be saved.

The socket 217 is, for example, a TCP socket and performs communication in a state where the connection is established. The connection by the socket 217 is established based on the IP address and port number at a server. The communication control unit 111 may be the server, or the robot service 213 may be the server. n may be any number. m may be any number as long as being less than n.

The robot service 213 may be configured to change the number of the m sockets 217 based on an occupancy status of the m sockets 217 by the n requests. Both saving of communication resources and smooth communication can be achieved.

The occupancy status is, for example, the ratio of sockets 217 among the m sockets 217 that are occupied by any of the n requests. For example, when the occupancy status is high and timely communication is difficult with the m sockets 217, the robot service 213 may increase the number of sockets 217. Conversely, when the occupancy status is low and timely communication may be performed with fewer than m sockets 217, the robot service 213 may decrease the number of sockets 217.

The robot service 213 may be configured to: allocate response memory 214 for each of the n requests; store a received response corresponding to each of the n requests in a corresponding memory 214; and return the response stored in the memory 214 to the application that originated the corresponding request. Receiving requests from applications, performing communication via the socket 217, and returning responses to applications can be performed independently. Accordingly, multiple requests from multiple applications can be flexibly responded.

For example, the robot service 213 may perform communication with the application 211 and communication with the communication control unit 111 at mutually independent timings. Hereinafter, communication with the application 211 is referred to as “first communication”, and communication with the communication control unit 111 is referred to as “second communication”. For example, the robot service 213 includes a queue 218 and stores n requests received from one or more applications by the first communication in the queue 218. The robot service 213 sequentially dequeues, from the queue 218, the requests stored in the queue 218, allocates a memory 214 corresponding to the dequeued request. After allocating the memory 214, the robot service 213 transmits the request to the communication control unit 111 by the second communication and stores the response (response to a one-time request or response ID to a cyclic request) received from the communication control unit 111 in the memory 214. The robot service 213 reads out the response from the memory 214 at a timing independent of the second communication. The robot service 213 returns the read response to the application that originated the request corresponding to the memory 214 by the first communication.

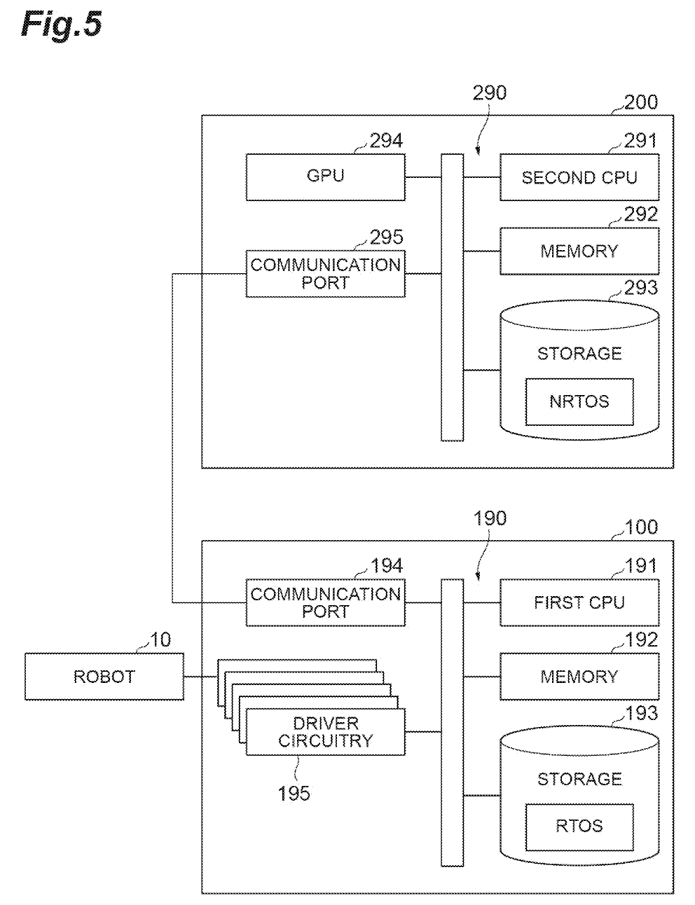

FIG. 5 illustrates an example hardware configuration of the robot drive device 100 and the computing device 200. As illustrated in FIG. 5, the robot drive device 100 includes circuitry 190, and the computing device 200 includes circuitry 290. The circuitry 190 includes a first CPU 191, a memory 192, a storage 193, a communication port 194, and driver circuitry 195. The storage 193 stores a program for controlling the robot 10 and for performing cyclic communication and acyclic communication with the computing device 200. The program includes, for example, a real-time OS, the above-described robot program, and a program for configuring the above-described functional blocks in the robot drive device 100. The storage 193 includes, for example, one or more non-volatile storage media. The non-volatile storage media include one or more storage devices. Examples of the one or more storage devices include a hard disk drive, a solid-state drive, and a flash memory. The non-volatile storage media may include a portable storage medium such as an optical disc.

The memory 192 temporarily stores a program loaded from the storage 193. The memory 192 includes one or more volatile storage media. The volatile storage media include one or more memory devices. Examples of the one or more memory devices include random-access memory. The first CPU 191 executes the program loaded into the memory 192 to configure the above-described functional blocks in the robot drive device 100. The first CPU 191 may temporarily store computation results in the memory 192. The first CPU 191 is a centreal processing unit (CPU) and includes one or more computing devices. The one or more computing devices may be one or more cores.

The communication port 194 performs network communication with the computing device 200 in response to a request from the first CPU 191. The driver circuitry 195 supplies drive power to the above-described plurality of actuators in response to a request from the first CPU 191.

The circuitry 290 includes a second CPU 291, a memory 292, a storage 293, a GPU 294, a communication port 295, and 296. The storage 293 stores a program including an application for control of the robot 10. For example, the storage 293 the program includes a non-real-time OS and a program for configuring the above-described plurality of APIs 212 and functional blocks in the robot drive device 100.

The memory 292 temporarily stores a program loaded from the storage 293. The memory 292 includes one or more volatile storage media. The volatile storage media include one or more memory devices. Examples of the one or more memory devices include random-access memory. The second CPU 291 executes the program loaded into the memory 292 to configure the above-described functional blocks in the computing device 200, in cooperation with the GPU 294. The second CPU 291 and the GPU 294 may temporarily store computation results in the memory 292. The second CPU 291 includes one or more computing devices. The one or more computing devices may be, for example, one or more central processing units, or one or more cores included in one central processing unit. The GPU 294 includes, for example, one or more Graphics Processing Units specialized for parallel processing.

The communication port 295 performs network communication with the communication port 194 in response to a request from the second CPU 291. Thus, the second CPU 291 can communicate with the first CPU 191.

The second CPU 291 may be configured to cause the GPU 294 to perform a matrix operation related to generating a path for the robot 10 (for example, the above-described motion path) while the first CPU 191 is controlling the robot 10. The first CPU 191 may be configured to cause the robot 10 to move along the path based on computation results by the second CPU 291 and the GPU 294. By enabling the use of matrix operations by the GPU 294 for generating a path for the robot 10 while the first CPU 191 is controlling the robot, the functionality of the robot 10 can be readily expanded.

The GPU 294 may perform, as the above-described matrix operation, a matrix operation related to image processing for generating the path based on an image of a surrounding environment of the robot 10. The robot 10 can be controlled while reflecting the image processing result in the path.

The GPU 294 may perform, as the matrix operation, a matrix operation for checking interference between the robot 10 and a surrounding object of the robot 10 based on models of the robot 10 and the surrounding object. The robot 10 can be controlled while reflecting the interference result between the robot 10 and the surrounding object in the path.

### Control Procedure

As an example of the control method, a control procedure executed by the control system 20 is illustrated. This control procedure includes: driving the robot by the robot drive device 100; executing, by the computing device 200, an application for control of the robot 10 by the robot drive device 100; performing cyclic communication for cyclically communicating data between the robot drive device 100 and the computing device 200; and performing acyclic communication for non-cyclically communicating data between the robot drive device 100 and the computing device 200.

Hereinafter, the control procedure will be illustrated with reference to flowcharts. The illustrated control procedure includes a communication start procedure between the robot drive device 100 and the computing device 200, a request handling procedure in the computing device 200, an acyclic communication procedure, a request handling procedure in the robot drive device 100, a cyclic communication procedure in the robot drive device 100, and a cyclic communication procedure in the computing device 200.

### Communication Start Procedure

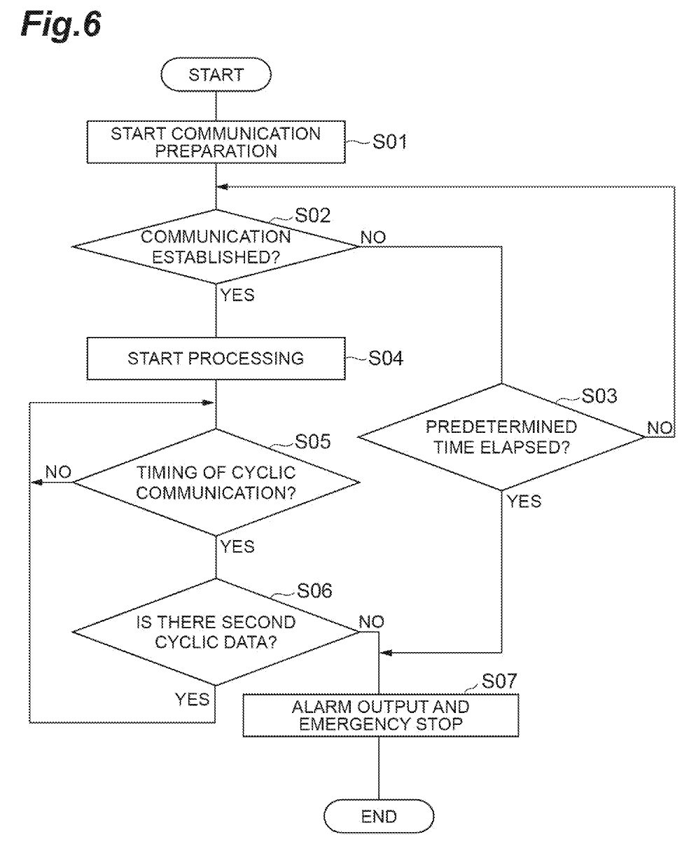

This procedure is a procedure for establishing communication between the robot drive device 100 and the computing device 200 prior to the robot drive device 100 starting to drive the robot 10. As illustrated in FIG. 6, the robot drive device 100 and the computing device 200 first execute operation S01. In operation S01, either the robot drive device 100 or the computing device 200 requests the other to establish a connection using the above-described m sockets 217. Next, the robot drive device 100 executes operation S02. In operation S02, the communication control unit 111 checks whether the connections using the m sockets 217 have been established. If it is determined in operation S02 that the connection has not yet been established, the robot drive device 100 executes operation S03. In operation S03, the communication control unit 111 checks whether a predetermined time has elapsed since the start of operation S01. If it is determined in operation S03 that the predetermined time has not elapsed, the robot drive device 100 returns the process to operation S02. Thereafter, the robot drive device 100 waits for either the communication to be established or the predetermined time to elapse.

If it is determined in operation S02 that the connection using the m sockets 217 has been established, the robot drive device 100 executes operation S04. In operation S04, the processing unit 114 starts processing (the above-described control cycle) for controlling the robot 10. Next, the robot drive device 100 executes operations S05 and S06. In operation S05, the watchdog unit 116 waits for the timing of cyclic communication. In operation S06, the watchdog unit 116 checks whether the communication control unit 111 has received the second cyclic data. If it is determined in operation S06 that the second cyclic data has been received, the robot drive device 100 returns the process to operation S05. Thereafter, at each timing of cyclic communication, it is checked whether the second cyclic data has been received.

If it is determined in operation S06 that the second cyclic data has not been received, or if it is determined in operation S03 that the predetermined time has elapsed, the robot drive device 100 executes operation S07. In operation S07, the watchdog unit 116 outputs an alarm and causes the robot 10 to perform an emergency stop. For example, the watchdog unit 116 displays an alarm to the operator on a display device or the like. After operation S07, the control procedure of the robot 10 is completed.

### Request Handling Procedure in Computing Device

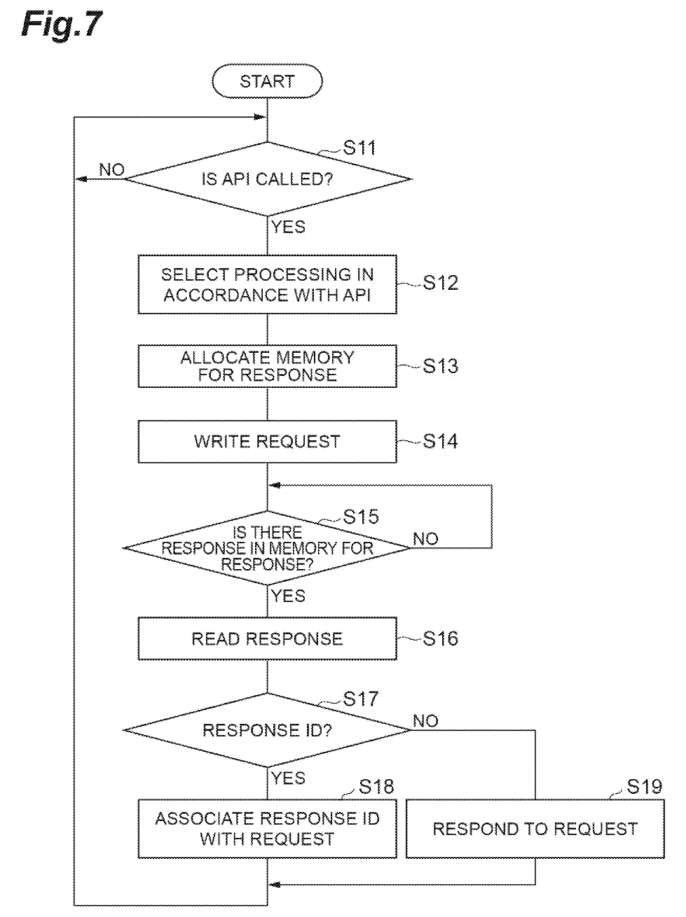

This procedure is a procedure in which the computing device 200 handles requests from the application 211 while the connection using the m sockets 217 is started and the robot drive device 100 is driving the robot 10. As illustrated in FIG. 7, the computing device 200 executes operations S11, S12, S13, and S14. In operation S11, the robot service 213 waits for any of the plurality of APIs 212 to be called. In operation S12, the robot service 213 selects processing corresponding to the called API 212. In operation S13, the robot service 213 allocates a response memory 214. In operation S14, a request to be transmitted to the communication control unit 111 is written into the queue 218. The request written into the queue 218 is transmitted to the communication control unit 111 in the acyclic communication procedure described later. When a response to the request is received, it is written into the memory 214.

Next, the computing device 200 executes operations S15 and S16. In operation S15, the robot service 213 waits for a response to be written into the memory 214. In operation S16, the robot service 213 reads out the response written into the memory 214.

Next, the computing device 200 executes operation S17. In operation S17, the robot service 213 checks whether the response read out from the memory 214 is a response ID for a response by cyclic communication. If it is determined in operation S17 that the response read out is a response ID, the computing device 200 executes operation S18. In operation S18, the robot service 213 stores the response ID in association with the request being handled.

If it is determined in operation S17 that the response read out is not a response ID, the computing device 200 executes operation S19. In operation S19, the robot service 213 returns the response to the application 211 that originated the request being handled. After executing operations S18 and S19, the computing device 200 returns the processing to operation S11. The computing device 200 repeats the above processing.

### Acyclic Communication Procedure

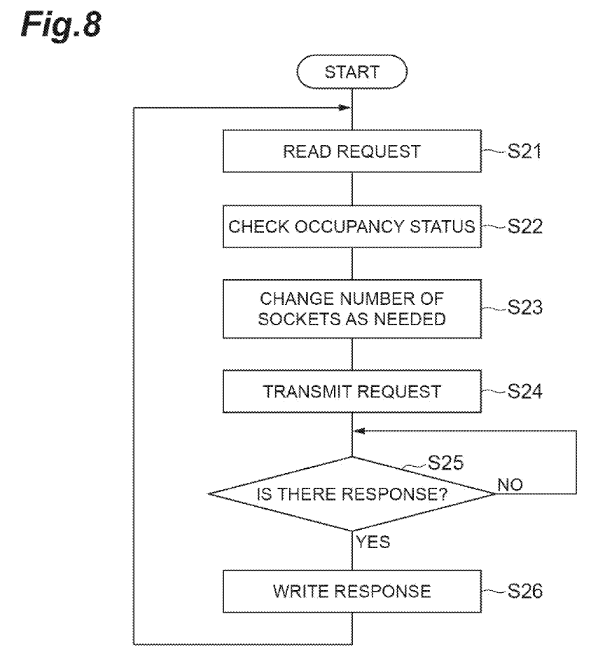

This procedure is a communication procedure executed by the computing device 200 according to the request written into the queue 218 in operation S14 described above. As illustrated in FIG. 8, the computing device 200 first executes operation S21. In operation S21, the robot service 213 reads out a request from the queue 218.

Next, the computing device 200 executes operations S22 and S23. In operation S22, the robot service 213 checks the occupancy status of the m sockets 217. In operation S23, the robot service 213 changes the number of sockets 217 as necessary based on the occupancy status of the m sockets 217.

Next, the computing device 200 executes operations S24, S25, and S26. In operation S24, the robot service 213 transmits the read request to the communication control unit 111. In operation S25, the robot service 213 waits for a response from the communication control unit 111. In operation S26, the robot service 213 writes the response from the communication control unit 111 into the memory 214. Thereafter, the computing device 200 returns the process to operation S21. The computing device 200 repeats the above processing.

### Request Handling Procedure in Robot Drive Device

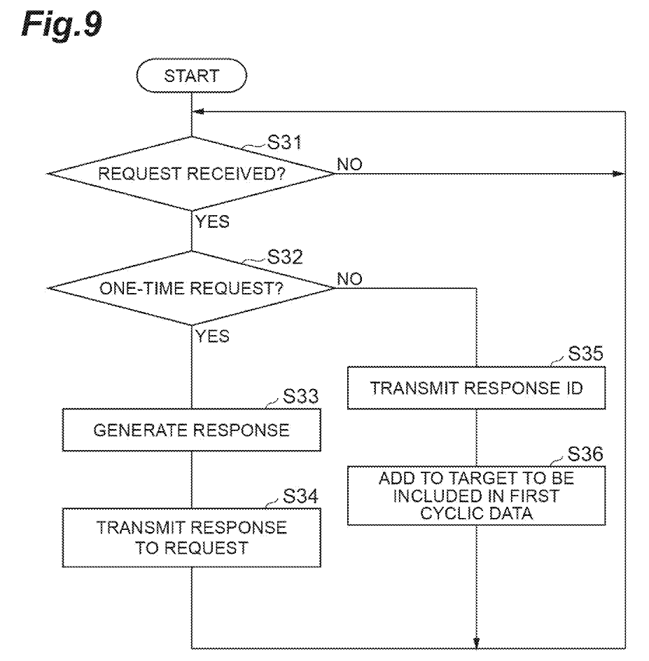

This procedure is a procedure in which the robot drive device 100 handles a request transmitted by the robot service 213 in operation S22 described above. As illustrated in FIG. 9, the robot drive device 100 first executes operations S31 and S32. In operation S31, the communication control unit 111 waits to receive a request. In operation S32, the communication control unit 111 checks whether the request is a one-time request.

If it is determined in operation S32 that the request is a one-time request, the robot drive device 100 executes operations S33 and S34. In operation S33, the processing unit 114 generates a response to the request received by the communication control unit 111. In operation S34, the communication control unit 111 transmits the response generated by the processing unit 114 to the robot service 213.

If it is determined in operation S32 that the request is a cyclic request, the robot drive device 100 executes operations S35 and S36. In operation S35, the communication control unit 111 issues a response ID for the cyclic request and transmits it to the robot service 213. In operation S36, the communication control unit 111 adds the response to the request to the target to be included in the first cyclic data. The response added to the target is included in the first cyclic data and transmitted by cyclic communication in the cyclic communication procedure described later. After executing operations S34 and S36, the robot drive device 100 returns the process to operation S31. The robot drive device 100 repeats the above processing.

### Cyclic Communication Procedure in Robot Drive Device

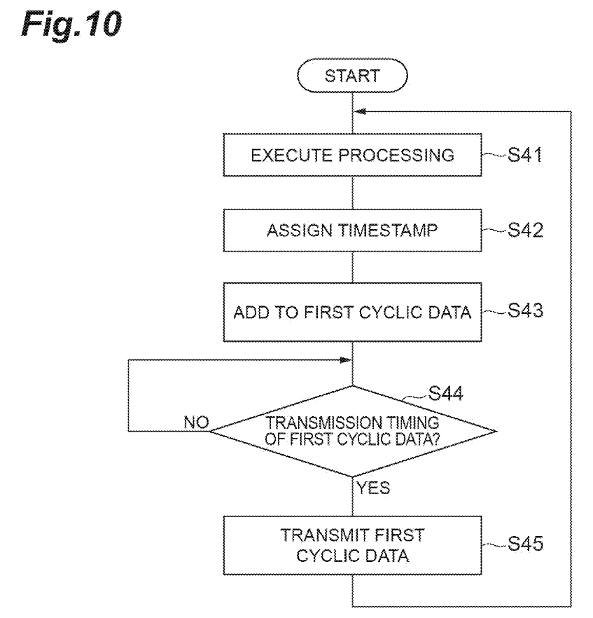

This procedure is a cyclic communication procedure executed by the robot drive device 100 after the connection by the socket 217 is established. As illustrated in FIG. 10, the robot drive device 100 executes operations S41, S42, S43, S44, and S45. In operation S41, the processing unit 114 executes processing such as the above-described control cycle. In operation S42, the timestamp assigning unit 115 assigns a timestamp to the processing result by the memory 214. In operation S43, the communication control unit 111 attaches the issued response ID to the processing result to be included in the first cyclic data among the processing results assigned with a timestamp, and adds the processing result with the response ID to the first cyclic data. In operation S44, the communication control unit 111 waits for the transmission timing of the first cyclic data. The transmission timing of the first cyclic data is, for example, the timing when the above-described control cycle elapses. In operation S45, the communication control unit 111 transmits the first cyclic data to the robot service 213. Thereafter, the robot drive device 100 returns the process to operation S41. The robot drive device 100 repeats the above processing.

### Cyclic Communication Procedure in Computing Device

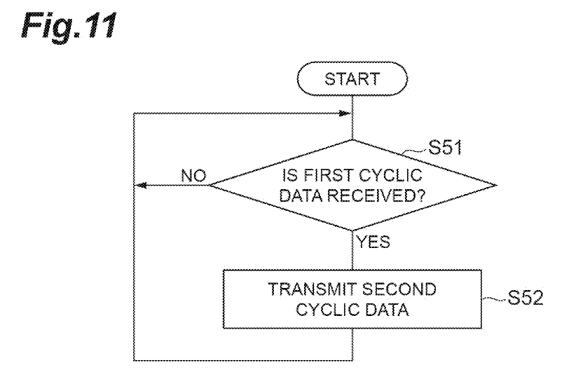

This procedure is a cyclic communication procedure executed by the computing device 200 after the connection by the socket 217 is established. As illustrated in FIG. 11, the computing device 200 executes operations S51 and S52. In operation S51, the robot service 213 waits to receive the first cyclic data. In operation S52, in response to receiving the first cyclic data, the robot service 213 transmits the second cyclic data to the communication control unit 111. Thereafter, the computing device 200 returns the process to operation S51. The computing device 200 repeats the above processing.

### Conclusion

(1) A robot system 1 comprising: a robot drive device 100 configured to drive a robot 10; and a computing device 200 configured to perform network communication with the robot drive device 100 and to execute an application 211 for control of the robot 10 by the robot drive device 100, wherein at least while the robot drive device 100 is driving the robot 10, a cyclic communication for cyclically communicating data and an acyclic communication for non-cyclically communicating data are performed between the robot drive device 100 and the computing device 200. With this robot system 1, resources for control of the robot 10 can be extended from the robot drive device 100 to the computing device 200, so that various processing or applications 211 for control of the robot 10 can be readily constructed beyond the resource constraints of the robot drive device 100. In addition, in the exchange of data and processing results for executing the processing or application 211, communication suitable for the nature of the processing or application 211 can be used between cyclic communication and acyclic communication. For example, by cyclic communication, data (for example, position data) corresponding to the driving period of the robot drive device 100 can be reliably transmitted and received. By acyclic communication, temporary information can be timely (for example, immediately) exchanged without generating a cyclic communication load. By combining these communications, timely communication can be performed while suppressing communication load while the robot drive device 100 is driving the robot 10. For example, data sets that are periodically updated or generated can be multiplexed onto cyclic data sent by cyclic communication, and data sets for which immediacy is prioritized rather than periodicity can be individually sent by acyclic communication, thereby enabling timely communication while suppressing communication load. Since the communication load is suppressed, a burden of the application developer to be aware of communication constraints at the time of application construction may be reduced, and a more straightforward development environment may be provided.

(2) The robot system 1 according to (1), wherein the robot drive device 100 comprises a communication control unit 111 configured to control the cyclic communication and the acyclic communication in response to a request from the computing device 200, and wherein the communication control unit 111 is configured to, to the computing device 200, transmit a response to the request by acyclic communication when the request is a one-time request; and transmit a response to the request by cyclic communication when the request is a cyclic request. In this robot system 1, the communication control unit 111 automatically assigns suitable communication in accordance with the nature of the request. Therefore, at least communication from the robot drive device 100 to the computing device 200 can be encapsulated, and the application 211 developer can benefit from a functional robot 10 development environment without being aware of communication.

(3) The robot system 1 according to (2), wherein the computing device 200 comprises: a plurality of APIs 212 callable from the application 211; and a robot service 213 configured to select one or both of a one-time request and a cyclic request according to the API 212 called from the application 211, and to transmit the selected request to the communication control unit 111. Communication from the computing device 200 to the robot drive device 100 can also be encapsulated. Since either a one-time request or a cyclic request is selected in accordance with the API 212, the application 211 can be readily constructed using the API 212 without being aware of the type of communication.

(4) The robot system 1 according to (2) or (3), wherein the computing device 200 is configured to transmit a cyclic request to the communication control unit 111 by acyclic communication, and the communication control unit 111 is configured to, in case of receiving the cyclic request, transmit a response to the request to the computing device 200 by cyclic communication. In this robot system 1, since the request from the computing device 200 is sent by acyclic communication, the request can be transmitted to the robot drive device 100 without waiting for the cycle of cyclic communication. In addition, if the request is a cyclic request, the response to the request can be included in the cyclic data repeatedly transmitted by cyclic communication. Accordingly, calculation cost and communication cost can be reduced.

(5) The robot system 1 according to any one of (2) to (4), wherein the communication control unit 111 is configured to: perform the cyclic communication and the acyclic communication with the computing device 200 using an identical communication resource; and prioritize the cyclic communication over the acyclic communication. In this robot system 1, the reliability of the cyclic communication can be maintained, and the robot system 1 capable of stable operation can be constructed.

(6) The robot system 1 according to (5), wherein the communication control unit 111 comprises: one or more queues for cyclic communication as queues configured to hold data sequentially sent to the computing device 200; and one or more queues for acyclic communication as queues configured to hold data sequentially sent to the computing device 200, wherein the communication control unit 111 is configured to, at a communication timing of the cyclic communication, prioritize data held in the one or more queues for cyclic communication over data held in the one or more queues for acyclic communication and to transmit the prioritized data to the computing device 200. With this robot system 1, since the queue for cyclic communication is prioritized over the queue for acyclic communication, the communication resource for cyclic communication can be prevented from being squeezed.

(7) The robot system 1 according to any one of (2) to (6), wherein the robot drive device 100 further comprises: a processing unit 114 configured to repeat processing for driving the robot 10 at a fixed cycle length; and a timestamp assigning unit 115 configured to assign a timestamp to a processing result, and wherein the communication control unit 111 is configured to transmit, by the cyclic communication, the processing result assigned with a timestamp by the timestamp assigning unit 115. Based on the timestamp, the computing device 200 can execute processing while reducing the influence of jitter and latency in the cyclic communication.

(8) The robot system 1 according to any one of (1) to (7), wherein the computing device 200 further comprises a robot service 213 configured to: sequentially transmit n requests from one or more applications 211 to the robot drive device 100 using m sockets 217, wherein m is fewer than n; and receive a response to each of the n requests via the m sockets 217, and return each received response to a corresponding request. With this robot system 1, communication resources can be saved.

(9) The robot system 1 according to (8), wherein the robot service 213 is configured to: allocate response memory 214 for each of the n requests; store a received response corresponding to each of the n requests in a corresponding memory 214; and return the response stored in the memory 214 to the application 211 that originated the corresponding request. Receiving requests from applications 211, performing communication via the socket 217, and returning responses to applications 211 can be performed independently. Accordingly, multiple requests from multiple applications 211 can be flexibly responded.

(10) The robot system 1 according to (8), wherein the robot service 213 is configured to change the number of the m sockets 217 based on an occupancy status of the m sockets 217 by the n requests. Both saving of communication resources and immediacy of communication can be achieved.

(11) The robot system 1 according to (1), wherein the robot drive device 100 comprises a communication control unit 111 configured to control the cyclic communication and the acyclic communication with the computing device 200, wherein the communication control unit 111 is configured to repeatedly transmit first cyclic data to the computing device 200 by cyclic communication regardless of whether there is information to be transmitted by the cyclic communication. With this robot system 1, since the cyclic data is periodically sent to the computing device 200 by cyclic communication, various processing can be constructed on the assumption that data is periodically received by cyclic communication in the computing device 200. For example, the computing device 200 can determine that communication with the robot drive device 100 is maintained by the periodic arrival of cyclic data. Also, processing synchronized with the processing in the robot drive device 100 can be executed based on the timing of receiving cyclic data.

(12) The robot system 1 according to (11), wherein the communication control unit 111 is configured to transmit the first cyclic data to the computing device 200 by performing the cyclic communication at a period synchronized with the driving period of the robot 10 in the robot drive device 100. With this robot system 1, since the cyclic data is sent at a cycle synchronized with the control cycle of the robot 10, the computing device 200 can perform calculation synchronized with the control cycle of the robot 10.

(13) The robot system 1 according to (12), wherein the computing device 200 is configured to perform, in response to receiving data from the robot drive device 100, a clock announcement to the application 211 executed on the computing device 200. With this robot system 1, the application 211 executed in the computing device 200 can acquire the timing synchronized with the control cycle of the robot 10 by the clock announcement and can execute processing in accordance with the timing. Therefore, the burden on a system integrator or service vendor constructing the application 211 executed in the computing device 200 can be greatly reduced.

(14) The robot system 1 according to (12), wherein the computing device 200 is configured to transmit second cyclic data to the robot drive device 100 by cyclic communication regardless of whether there is information to be transmitted by the cyclic communication, and wherein the robot drive device 100 comprises a watchdog unit 116 configured to confirm an integrity of the communication with the computing device 200 based on the second cyclic data. With this robot system 1, the robot drive device 100 can confirm that the computing device 200 is operating and capable of communication. This confirmation result can also be used as a control condition for error, alarm, emergency stop, or branching of processing in the robot drive device 100.

(15) The robot system 1 according to (14), wherein the computing device 200 is configured to include an emergency stop signal in the second cyclic data and transmit the second cyclic data to the robot drive device 100 so as to cause the robot drive device 100 to perform an emergency stop, and the robot drive device 100 is configured to, when the second cyclic data includes the emergency stop signal, perform an emergency stop of the robot 10. With this robot system 1, by utilizing the second cyclic data periodically transmitted to the robot drive device 100, the computing device 200 can cause the robot drive device 100 to perform an emergency stop. Even if the second cyclic data including the emergency stop signal is not transmitted due to a communication failure, the robot drive device 100 can be caused to perform an emergency stop based on the monitoring result by the watchdog unit 116. In addition, when the cyclic communication is performed at a period less than or equal to the control cycle of the robot drive device 100, the second cyclic data is also transmitted at a cycle less than or equal to the control cycle of the robot drive device 100, so the number of control cycles executed until the emergency stop signal is transmitted can be reduced, and the robot drive device 100 can be quickly stopped in an emergency.

(16) The robot system 1 according to (14), wherein the watchdog unit 116 is configured to start confirming the integrity based on the second cyclic data after the communication control unit 111 establishes the cyclic communication. Erroneous detection of loss of integrity in a situation where merely waiting for the establishment of cyclic communication can be prevented.

(17) A robot system 1 comprising: a first CPU configured to control the robot 10 by executing a real-time OS; a second CPU communicable with the first CPU and configured to execute a non-real-time OS; and a GPU controlled by the second CPU, wherein the second CPU is configured to cause the GPU to perform a matrix operation related to generating a path for the robot 10 while the first CPU is controlling the robot 10, and wherein the first CPU is configured to, based on computation results by the second CPU and the GPU, cause the robot 10 to move along the path. By enabling the use of matrix operations by the GPU for generating a path for the robot 10 while the first CPU is controlling the robot 10, the functionality of the robot 10 can be readily expanded.

(18) The robot system 1 according to (17), wherein the matrix operation includes a matrix operation related to image processing for generating the path based on an image of a surrounding environment of the robot 10. The robot 10 can be controlled while reflecting the image processing result in the path.

(19) The robot system 1 according to (18), wherein the GPU is configured to perform, as the matrix operation, a matrix operation for checking interference between the robot 10 and a surrounding object of the robot 10 based on models of the robot 10 and the surrounding object. The robot 10 can be controlled while reflecting the interference result between the robot 10 and the surrounding object in the path.

(20) The robot system 1 according to (18), wherein the second CPU is configured to perform network communication with the first CPU. The flexibility of data that can be communicated is increased, and the GPU can be utilized more flexibly.

(21) A control method comprising: driving the robot 10 by the robot drive device 100; executing, by the computing device 200 configured to perform network communication with the robot drive device 100, an application 211 for control of the robot 10 by the robot drive device 100; performing cyclic communication for cyclically communicating data between the robot drive device 100 and the computing device 200; and performing acyclic communication for non-cyclically communicating data between the robot drive device 100 and the computing device 200.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A robot system comprising:
a robot drive device configured to drive a robot; and
a computing device configured to perform network communication with the robot drive device and to execute an application for control of the robot by the robot drive device,
wherein, while the robot drive device is driving the robot, a cyclic communication for cyclically communicating data and an acyclic communication for non-cyclically communicating data are performed between the robot drive device and the computing device by the network communication.

2. The robot system according to claim 1, wherein the robot drive device is configured to:
control the cyclic communication and the acyclic communication in response to a request from the computing device;
transmit, to the computing device, a response to the request by the acyclic communication in response to determining that the request is a request for one-time response; and
transmit, to the computing device, a response to the request by the cyclic communication in response to determining that the request is a request for cyclic response.

3. The robot system according to claim 2, wherein the computing device comprises a plurality of APIs callable from the application, and
wherein the computing device is configured to:
select one or both of the request for one-time response and the request for cyclic response according to an API called from the application; and
transmit the selected request to the robot driving device.

4. The robot system according to claim 2, wherein the computing device is configured to transmit the request for cyclic response to the robot drive device by the acyclic communication, and
wherein the robot drive device is configured to, in response to receiving the request for cyclic response, transmit a response to the request to the computing device by the cyclic communication.

5. The robot system according to claim 2, wherein the robot drive device is configured to:
perform the cyclic communication and the acyclic communication with the computing device using an identical communication resource; and
prioritize the cyclic communication over the acyclic communication.

6. The robot system according to claim 5, wherein the robot drive device comprises:
one or more queues for cyclic communication configured to hold data to be sequentially sent to the computing device; and
one or more queues for acyclic communication configured to hold data to be sequentially sent to the computing device, and
wherein the robot drive device is configured to, at a communication timing of the cyclic communication, prioritize data held in the one or more queues for cyclic communication over data held in the one or more queues for acyclic communication and to transmit the prioritized data to the computing device.

7. The robot system according to claim 2, wherein the robot drive device is further configured to:
repeat processing for driving the robot at a fixed period;
assign a timestamp to a processing result; and
transmit, by the cyclic communication, the processing result with the assigned timestamp.

8. The robot system according to claim 1, wherein the computing device is further configured to:
sequentially transmit n requests from one or more applications to the robot drive device using m sockets, wherein m is fewer than n; and
receive a response to each of the n requests via the m sockets, and return the received response to a corresponding request.

9. The robot system according to claim 8, wherein the computing device is configured to:
allocate memory for a response for each of the n requests;
store the received response in an allocated memory; and
return the response stored in the allocated memory to the application that originated the request.

10. The robot system according to claim 8, wherein the computing device is configured to change number of the m sockets based on an occupancy status of the m sockets by the n requests.

11. The robot system according to claim 1, wherein the robot drive device is configured to:
control the cyclic communication and the acyclic communication with the computing device; and
repeatedly transmit first cyclic data to the computing device by the cyclic communication even when there is no information to be transmitted by the cyclic communication.

12. The robot system according to claim 11, wherein the robot drive device is configured to transmit the first cyclic data to the computing device by performing the cyclic communication at a cycle synchronized with a driving period of the robot in the robot drive device.

13. The robot system according to claim 12, wherein the computing device is configured to perform, in response to receiving data from the robot drive device, a clock announcement to the application executed on the computing device.

14. The robot system according to claim 12, wherein the computing device is configured to transmit second cyclic data to the robot drive device by the cyclic communication even when there is no information to be transmitted by the cyclic communication, and
wherein the robot drive device is configured to confirm an integrity of the communication with the computing device based on the second cyclic data.

15. The robot system according to claim 14, wherein the computing device is configured to include an emergency stop signal in the second cyclic data and transmit the second cyclic data to the robot drive device so as to cause the robot drive device to perform an emergency stop, and
wherein the robot drive device is configured to, in response to determining that the second cyclic data includes the emergency stop signal, cause the robot to perform an emergency stop.

16. The robot system according to claim 14, wherein the robot drive device is configured to start confirming the integrity based on the second cyclic data after establishing the cyclic communication.

17. A robot system comprising:
a first CPU configured to control a robot by executing a real-time operating system;
a second CPU communicable with the first CPU and configured to execute a non-real-time operating system; and
a GPU controlled by the second CPU,
wherein the second CPU is configured to cause the GPU to perform a matrix operation related to generating a path for the robot while the first CPU is controlling the robot, and
wherein the first CPU is configured to, based on computation results by the second CPU and the GPU, cause the robot to move along the path.

18. The robot system according to claim 17, wherein the matrix operation includes a matrix operation related to image processing for generating the path based on an image of a surrounding environment of the robot.

19. The robot system according to claim 18, wherein the GPU is configured to perform, as the matrix operation, a matrix operation for checking interference between the robot and a surrounding object of the robot based on models of the robot and the surrounding object.

20. A control method comprising:
driving a robot by a robot drive device;
executing, by a computing device configured to perform network communication with the robot drive device, an application for control of the robot by the robot drive device; and
performing, while the robot drive device driving the robot, a cyclic communication for cyclically communicating data and an acyclic communication for non-cyclically communicating data between the robot drive device and the computing device by the network communication.
